(19) United States
(12) Patent Application Publication
(10) Pub. No.: US 2016/0379288 A1
(43) Pub. Date: Dec. 29, 2016

(54) Integrated Meal Plan Generation and Supply Chain Management

(71) Applicant: Wal-Mart Stores, Inc., Bentonville, AR (US)

(72) Inventors: Bruce Walter Wilkinson, Rogers, AR (US); Kimberly Sue Houchens, Rogers, AR (US)

(21) Appl. No.: 15/192,432

(22) Filed: Jun. 24, 2016

Related U.S. Application Data
(60) Provisional application No. 62/186,146, filed on Jun. 29, 2015.

(51) Int. Cl. G06Q 30/06; G06Q 30/02; G06Q 10/08; G06Q 10/06; H04L 29/08; G06F 17/30

(52) U.S. Cl. CPC G06Q 30/0621; H04L 67/306; G06F 17/30598; G06Q 10/083; G06Q 10/06311; G06Q 30/0201

(57) ABSTRACT

A customer profile for each user of a plurality of users is generated based on purchase history and reception of meals by the each user. A preferential fabric for each user is generated based on attributes of ingredients and dishes preferred by the user according to the user's customer profile. Users are clustered together according to the similarities of the preferential fabrics thereof. A sample product is selected based on its attributes having a high correspondence to the preferential fabrics of the users of a cluster. The sample product is transmitted to a portion of the users of the cluster and a response thereto is evaluated. In response to positive reception, direct shipment of the sample product to the cluster is invoked, bypassing a retail store. The sample product may therefore have a shelf life shorter than required to stock the sample product in a conventional retail store.

### CROSS-REFERENCE TO RELATED APPLICATIONS

This application claims the benefit of U.S. Provisional Patent Application 62/186,146, filed Jun. 29, 2015, and titled “Integrated Meal Plan Generation and Supply Chain Management”, the entire contents of which are hereby incorporated herein by reference.

### BACKGROUND

### Field of the Invention

This invention relates to systems and methods for delivering meal ingredients to customers.

### Background of the Invention

Cooking delicious meals from basic ingredients is a great way to eat healthy. Trying out new recipes and enjoying the results is also enjoyable for many people. For people that work long hours or have small children, it may be difficult to find the time to buy fresh ingredients, even if one has the time to actually cook the meal. Likewise, it may take considerable time to review cooking magazines or recipe websites in order to find new recipes to try. A person may need to actually make many recipes before finding one that actually is suitable for the person's tastes.

The systems and methods described herein below provide an engine that invokes delivery of meals that have a high likelihood of satisfying a person's tastes.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing methods in accordance with embodiments of the invention;

FIG. 2 is a schematic block diagram of an example computing device suitable for implementing methods in accordance with embodiments of the invention;

FIG. 3 is a process flow diagram of a method for invoking delivery of meal ingredients to users in accordance with an embodiment of the present invention; and

FIG. 4 is a process flow diagram of a method for selecting and providing a sample product to a cluster of users in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

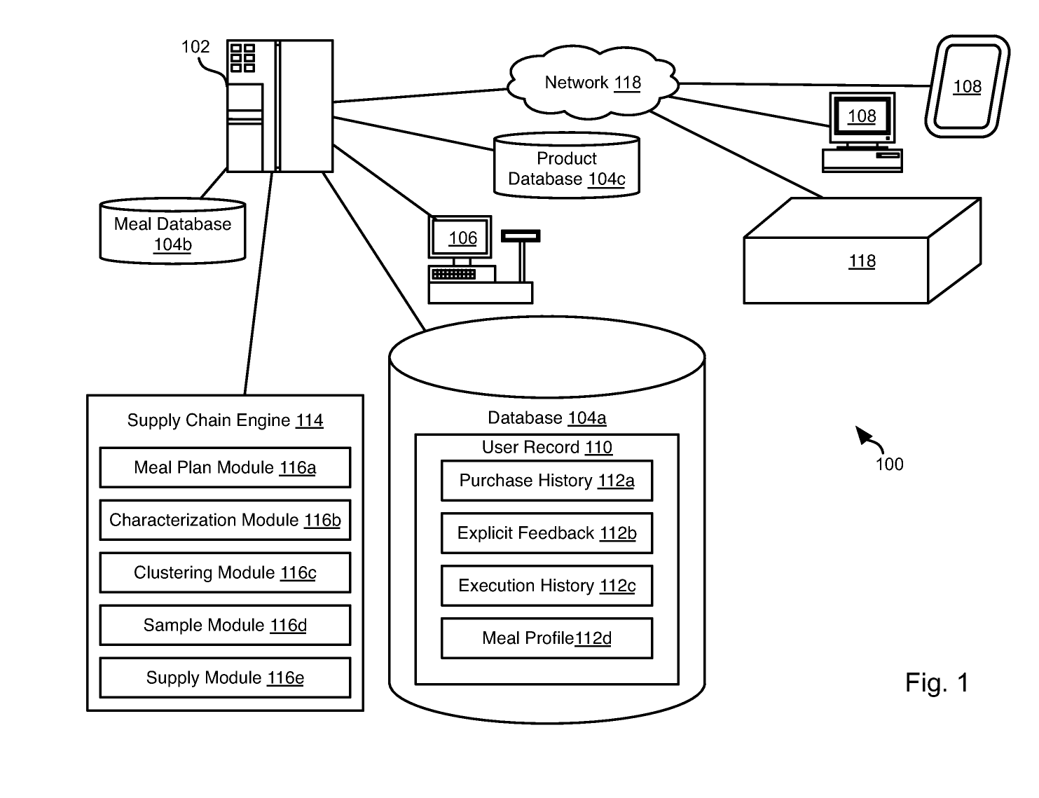

Referring to FIG. 1, a network environment 100 may be used to implement methods as described herein. The environment 100 may include a server system 102 associated with a corporate parent or controlling entity having one or more retail establishments associated therewith. The server system 102 may host or access a database 104a of user data, a meal database 104b, and a product database 104c, which are described in greater detail below. The retail establishments may house point of sale devices (POS) 106 on which transactions may be concluded. The POS 106 may also be part of an e-commerce system. The e-commerce system may include, for example, a web-application that permits customers to purchase various products and/or services over the Internet. POSs 106 in communication with the server system 102 may include POSs 106 associated with a warehouse store that is a separate entity or format than the retail establishments.

Online POSs 106 may interact with remote user computers 108. In particular, server system 102 may host a website that may be browsed by users on the user computers 108 and through which the users may invoke purchase and shipment of products in a product database 104c. The remote user computers 108 may be embodied as laptop or desktop computers, mobile phones, tablet computers, wearable computers, or other computing device.

Records of transactions may be transmitted to the server system 102 by the POSs 106 at one or more outlets, e.g. retail establishments, warehouse stores, and ecommerce systems. The records of various transactions from the various outlets may be associated to individual customers. Specifically, unique data such as a credit card number, address, username, membership number, and the like may be associated with a particular customer. Accordingly, transaction records including one or more items of this unique data may be associated with that user. For example, transaction records determined to be associated with a particular user may be stored in a user record 110 for that user in the database 104a, such as in a purchase history 112a of the user record 110.

The user record 110 for that user may further include records of other information received from a user or gathered from observation of user actions. For example, the user record 110, may include explicit feedback 112b, an execution history 112c, and a meal profile 112d. Explicit feedback 112b may include responses of the user to questions regarding the user's tastes (e.g. food style, ingredients, etc.) or specific meals presented to the user as part of a meal plan or actually prepared by the user. The manner in which the execution history 112c and meal profile 112d are obtained and used is described in greater detail below.

The server system 102 may execute a supply chain engine 114 executing the methods described herein. A meal plan module may select meal plans and meals for each customer of a plurality of customers based on the data contained in the user record 110. The meal plan module 116a may, for example, identify in the meal database 104b meals including ingredients and/or types of food that correspond to the meal profile 112d of a user and transmit media files from the meal database 104b that correspond to the meals to the user, e.g. a user device 108 associated with that user. The media file transmitted for a meal of the meal plan may include an instructional video that instructs the user how to prepare the meal.

The supply chain engine 114 may include a characterization module 116b effective to identify, for each user, the preferential fabric of the each customer. The preferential fabric may include common attributes of items of the purchase history of the each customer and ingredients of meal plans of the meal plan history of the each customer.

For example, in some embodiments, the meal profile 112d of a user may additionally or alternatively include the “preferential fabric” of the user. In particular, rather than simply extracting styles of food and lists of ingredients, the preferential fabric may be generated by identifying attributes of ingredients determined to be liked by the user due to purchase or use in meal plans that are determined to be executed or otherwise well received by the user. For example, ingredients may have attributes such as fresh, organic, prepared, microwavable, or other adjectives that can be descriptive of an ingredient. Attributes may include any adjective that may be used to describe food, e.g. bitter, crispy, moist, crisp, juicy, citrus, etc. Adjectives describing ingredients or meals determined to be liked by a user may be derived from a reference corpus having articles describing a meal or part of a meal or an ingredient of a meal. The reference corpus may advantageously be cooking-specific and authored by chefs or food critics that will use descriptive and vibrant language to describe dishes and ingredients. This language may then be used to populate a description list of adjectives or descriptors for each dish and ingredient of some or all dishes and ingredients included in the purchase history or meal plans of users. The meal profile 112d may then be populated with a preferential fabric of adjectives/descriptors and their frequency of occurrence in the description lists for ingredients and meals determined to be liked by the user. The adjectives/descriptors in a preferential fabric may include a metric that is determined according to a function that increases with a frequency of occurrence of the adjective/descriptor in the ingredients and dishes determined to be liked by the user and that increases with the frequency of purchase of the ingredient or frequency of preparation of the dish by the user.

The supply chain engine 114 may include a clustering module 116c effective to analyze the preferential fabrics of the users and/or other portions of the meal profile 112d of the users and identify a plurality of clusters of users, each cluster being identified as group of users from the plurality of users that have similar preferential fabrics. The identification of clusters may be performed using any clustering algorithm known in the art. For example, the preferential fabric may be embodied as a vector, each entry corresponding to a possible adjective or descriptor and the value of each entry being determined according to the function that increases with a frequency of occurrence of the adjective/descriptor in the ingredients and dishes determined to be liked by the user and that increases with the frequency of purchase of the ingredient or frequency of preparation of the dish by the user.

Users may then be clustered by analysis of the preferential fabrics according to any method known in the art such as k-means clustering or the like. Users may be clustered by determining that the dot products of the preferential fabrics of the users with respect to one another exceed a threshold similarity to one another. Other clustering algorithms known in the art may also operate on the preferential fabrics in order to group users into clusters of similar users.

A sample module 116d may for each cluster of at least a portion of the plurality of clusters, select a sample product that is highly tuned to the preferential fabrics of the users in the each cluster. For example, the sample module 116d may (a) select, for at least one cluster of the plurality of clusters, a portion of the users of the at least one cluster, (b) identify a sample product having similarity to the preferential fabrics of the customers of the at least one cluster meeting a threshold condition, (c) invoke shipping of a sample product to the portion of the users of the at least one cluster, the sample product having attributes corresponding to the preferential fabrics of the users of the at least one cluster and (d) evaluate a response of the portion of the users of the at least one cluster to the sample product.

The supply chain engine 114 may include a supply module 116e. The supply module 116e may invoke ordering of sample products determined to be well received by the portions of the users of the clusters to whom the sample product has been sent. For example, the meal plan module 116a may select the sample product for inclusion in a meal scheduled on a common date for the users of the a cluster if the response of the portion of the users of the cluster meets a threshold condition. The supply module 116e may invoke ordering and delivery of the sample product on the common date to the users of the cluster within a usable lifetime of the sample product. In particular, the supply module may facilitate ordering and direct shipment of a sample product having a usable lifetime that is shorter than a time required to stock the sample product in a retail establishment for individual sale.

In some embodiments deliveries of ingredients of a meal, including sample products selected as described above, may be made in crates 118 that include a processor and wireless communication devices. The crates 118 may detect presence of proximity of a user device 108 and transmit a notification of the detection to the server system 102, thereby notifying the server system 102 that a delivery including in a crate 118 has been retrieved. Alternatively, the crates 118 may transmit a notification to a user device 108 upon detecting proximity of the user device 108. In response to this notification, the user device 108 may be programmed to report the notification to the server system 102 thereby indicating a delivery in the smart crate has been retrieved. In some embodiments, crates 118 may each have keypads and be configured such that upon input of a code, the crates 118 notify the server 102 of retrieval of the delivery contained in the crate, either directly or by notifying a user computer device 108 located proximate the crate, which then reports the notification to the server system 102.

The server system 102 may be in data communication with some or all of the POSs 106, user computers 108, and crates 118 by means of a network 120. The network 120 may include any wired or wireless connections and may include some or all of a local area network (LAN), wide area network (WAN), the Internet, or other type of network.

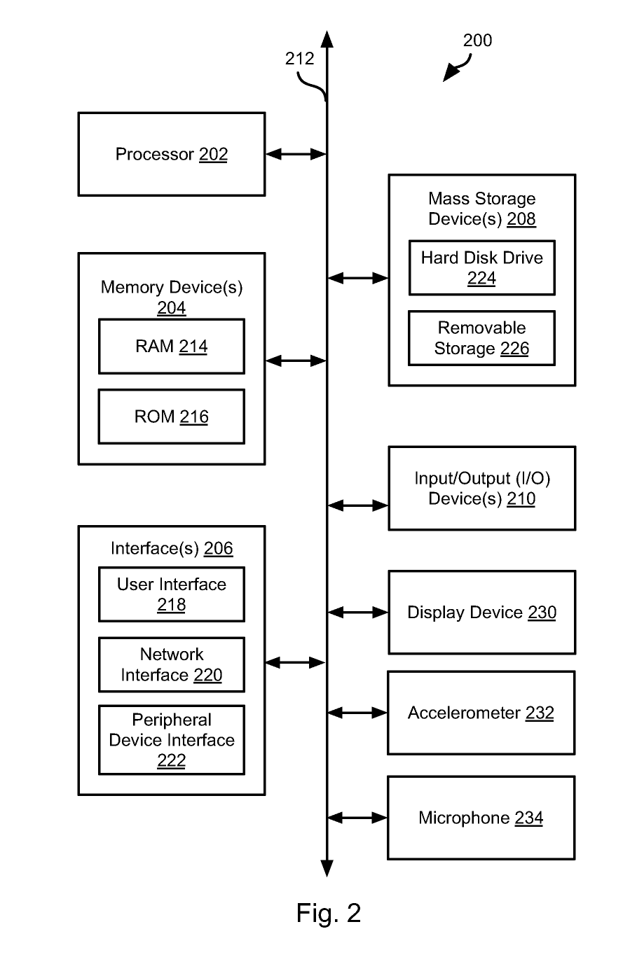

FIG. 2 is a block diagram illustrating an example computing device 200. Computing device 200 may be used to perform various procedures, such as those discussed herein. The server system 102, POSs 106, user computers 108, and crate 118 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, a tablet computer and the like. A server system 102 may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

A computing device 200 implementing the user computers 108 may advantageously include one or more sensors. The output of these sensors may be used to determine whether a media file is viewed solely for inspiration or viewed during execution of a meal that the media file instructs how to prepare. In some embodiments, the sensors include an accelerometer 232 that detects acceleration of the user computer 108 in which it is included as well as the orientation thereof. In some embodiments, the sensors further include a microphone 234 capable of detecting sounds incident on the user computer 108.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

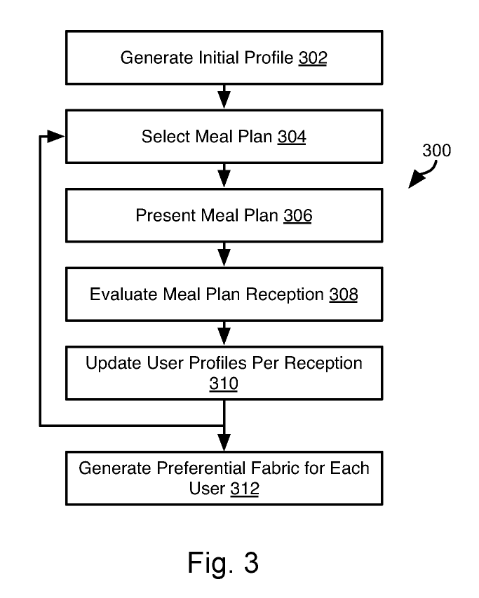

Turning now to FIG. 3, the illustrated method 300 may be executed by the server system 102 with respect to each user record 110 of a plurality of user records, the user record representing a specific customer, family, or other entity, hereinafter “the user.”

The method 300 may include generating 302 a profile, e.g. an initial meal profile 112d for the user. The initial meal profile 112d may include information known about a user from the user record 110 or from previous iterations of the method 300. In particular, the initial meal profile 112d may include inferring favorite ingredients or styles of food from the purchase history of the user.

For example, the initial meal profile 112d may include generating a taste profile of the user from the purchase history 112a. For example, each transaction of the purchase history 112a may include a listing of product identifiers. The method 300 may include mapping product identifiers or groups of product identifiers to a particular type of food. For example, product identifiers for tortillas, salsa, cilantro, limes, etc. may correspond to Mexican food. Product identifiers for soy sauce, bean sprouts, etc. may correspond to Chinese food. Of course, some ingredients may be used in multiple styles of cooking, such as cilantro, which may be used in both Mexican and Chinese food. Accordingly, determining a taste profile may include identifying groups of ingredients in the same or different transaction that overlap with a grouping of ingredients corresponding to a particular style of food. The style of food having the greatest number of products of a transaction included in its grouping of ingredients as opposed to other styles of food may be determined to be the style of food for that transaction. The style of food preference may be determined for each transaction or based on an aggregation of products for a plurality of transactions. For example, each transaction, or a group of transactions that are temporally proximate (e.g. within 5, 10, 15, or N days apart), may be analyzed and a style of food identified therefore. The styles of foods identified for a plurality of transactions or plurality of groups of transactions may be determined. The top M styles of foods, e.g. having the top M greatest numbers of transactions or groups of transactions mapped thereto may be selected as the customer's preferred styles of food. Attributes of meals determined from the ingredients may further include values of aesthetics, nutritional value, health benefits, and the like. Any methods known in the art may be used to determine the user's taste preference based on past purchases.

Generating 302 the meal profile 112d may include generating the taste profile as described above from a purchase history 112a as well as from explicit feedback 112b regarding meals presented to the user, e.g. including in the profile 112d data that indicates favorability of the user for attributes of meals the user indicated a liking for and indicates disfavor for attributes of meals the user indicated a dislike for. Generating 302 the profile may include storing in the profile 112d data indicating favoring of the user for attributes of meals actually executed by the user as determined according to the methods described herein. Generating 302 the profile may include storing in the profile 112d data indicating disfavoring of the user for attributes of meals not actually executed by the user as determined according to the methods described herein. The attributes of meals may include ingredients of the meals, a style of food of the meals, or any other attributes of the meal or portion of the meal.

The method 300 may further include selecting 304 a meal plan according to the meal profile 112d. For example, the meal database 104b may store a plurality of meals, i.e. data describing the meal including the ingredients, style of food, cooking methods, recipes, and instructional media files. Selecting 304 the meal plan may include selecting a set of meals that include ingredients, style of foods, and/or other attributes found in the meal profile 112d of the user. The meals selected 304 may also be selected so as to include diverse meals that provide an appropriate amount of variety while still corresponding to the meal profile 112d of the user. The selecting 304 of a meal plan may be performed by the meal plan module 116a.

The method 300 may include presenting 306 the meal plan. Presenting 306 the meal plan may include transmitting media files, or information sufficient to enable access of media files. The media files may each include content instructing how to prepare a meal of the meal plan.

Presenting the meal plan may further include invoking shipment of some or all of the ingredients of each meal selected at step 304 on a date the each meal is scheduled according to the meal plan. For example, presenting a pick list listing both the ingredients of the meal selected at step 304 and an appropriate amount of refrigerant, ice packs. Invoking shipment may include outputting to a computing device or printer a graphical representation of the pick list to facilitate retrieval of the refrigerant and ingredients listed on the pick list. The pick list may be presented on a computing device as part of an interface that received user inputs checking off items of the pick list as they are retrieved. Invoking shipment may include programming a smart crate 118 with user information sufficient to enable the smart crate 118 to detect the user computing device 108 of the appropriate user for whom the delivery is intended. Invoking shipment may include programming the smart crate 118 to open for a key code associated with the appropriate user. Invoking shipment may include generating routing information, labels for a carrier, or other information required to perform shipment of the crate 118. Electronic messages to a carrier may also be sent as part of step 306 that instruct the carrier to pick up the package and may include an address or other information for the delivery of the crate 118 to the appropriate user.

The method 300 may further include evaluating 308 user reception of the meals presented at step 306 and updating 310 the meal profile 112d according to the user's reception of the meal selected at step 304. User reception of the meal may be determined based on explicit feedback from the user, e.g. a survey transmitted by the server system 102 to the user and a response to the survey received from the user. In particular, the meal profile 112d may be updated 310 to favor selection of meals having ingredients and styles of food similar to the selected 304 meal if the user reception is positive and to disfavor selection of meals having ingredients and styles of food similar to the selected 304 meal if the user reception is negative.

User reception of the presented 306 meals may be evaluated 308 based on an evaluation of user actions. For example, presenting 306 a meal of a meal play may include transmitting a media file to the user device of the user. User actions with respect to that media file may be evaluated. If the user actions include playing back the media file with pausings corresponding to performance of cooking steps, then the media file may be determined to have been well received, i.e. actually executed by the user. If the user actions include no playback or playback with no pausing, then the media file may be deemed not to have been viewed to execute the meal and the selected 304 meal may be determined not to have been well received. Other actions may also be evaluated, such as sounds detected during playback, whether the user device 108 on which playback occurred was still during playback, or other user actions.

Steps 304-310 may be performed repeatedly and the meal profile 112d updated in order to continually. After a plurality of iterations (e.g. 10-100, or some other number) of some or all of steps 304-310, some or all of steps 312-324 may be performed according to information obtained from previous iterations of some or all of steps 304-310.

The method 300 may include generating 312 a preferential fabric for the user. Generating 312 the preferential fabric may include performing the functions attributed to the characterization module 116b hereinabove. As noted above, the preferential fabric of the user may be a vector or list of adjectives or other descriptors, where each entry for an adjective or other descriptor includes an entry that is a function that increases with a frequency of occurrence of the adjective/descriptor in the ingredients and dishes determined to be liked by the user and/or that increases with the frequency of purchase of the ingredient or frequency of preparation of the dish by the user.

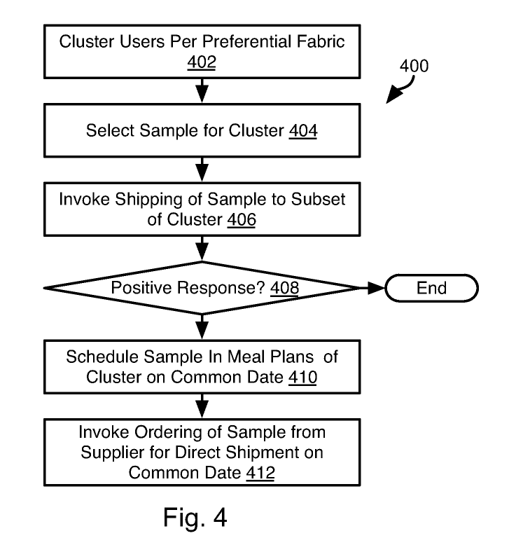

Referring to FIG. 4, the illustrated method 400 may be executed by the server system 102. The method 400 may include clustering 402 users into one or more clusters according to similarities of the preferential fabrics thereof. As noted above, this may be performed by the clustering module 116c. As also noted above, users may then be clustered by analysis of the preferential fabrics according to any method known in the art such as k-means clustering or the like. Users may be clustered by determining that the dot products of the preferential fabrics of the users with respect to one another exceed a threshold similarity to one another. Other clustering algorithms known in the art may also operate on the preferential fabrics in order to group users into clusters of similar users.

The method 400 may include selecting 404 a sample product for a cluster. The sample product may be selected by the sample module 116d. In particular, selecting 404 a sample product for the cluster may include selecting a sample product having a very high similarity to the preferential fabrics of the users of the cluster. For example, the preferential fabrics of the users of a cluster may be summed or otherwise combined to obtain a cluster fabric. A sample product having a high similarity to the cluster fabric may then be identified. For example, the sample product may be sample product having a similarity to the cluster fabric that exceeds a threshold condition. For example, where the preferential fabrics of the users are vectors having values for a plurality of adjectives or other descriptors as described above, the cluster vector may be a sum of these vectors. A sample product may likewise have a vector including values for adjectives or other descriptors that apply to the sample product. A similarity between the sample product vector and the cluster vector may be determined, such as by calculating a dot product of the vectors or some other metric of similarity. If the metric of similarity exceeds a predetermined threshold, then the sample product may be selected 404. Alternatively, a sample product having the highest similarity score among a plurality of potential sample products may be selected 404.

The method 400 may further include invoking 406 shipment of units of the sample product selected 404 for the cluster to a subset of the users of the cluster. For example, the sample product may be added to the pick list of for meals to be shipped to the portion of the users as part of a meal plan, as described above with respect to FIG. 3.

The method 400 may further include evaluating 408 a response of the portion of the users to the units of the sample product. For example, the server system 102 may transmit survey questions to the portion of the users and receive responses back. If the responses indicate a percentage of the portion exceeding some percentage threshold likes or enjoys the sample product, then the response may be determined to be positive. Otherwise, the response may be deemed negative.

If the response is determined 408 to be positive, the method 400 may include scheduling 410 use of the sample product in meal plans of users of the cluster. In particular, meals including the sample product may be scheduled for the users of the cluster on a same date (“the common date”). In this manner, a bulk order for the sample product may be performed. In some instances, the sample product may be a product that is not readily stocked in stores due to a short shelf life. Accordingly, scheduling the meals including the sample product for a common date enables the expense of handling a time-sensitive product to be spread over a large number of users thereby enabling the provision of a product that cannot practically be sold in a typical retail environment.

The method 400 may further include invoking 412 ordering of the sample product from a supplier for direct shipment to the users of the cluster on the common date. In particular, invoking 412 ordering of the sample product may be performed by the supply module 116e and may include automated placing of orders for delivery by the common date from one or more suppliers. Likewise, other logistical actions required to transport the sample product from suppliers to user residences may be invoked, such as delivery of the sample product to one or more locations where crates 118 are loaded with ingredients for the meal scheduled for the common date, including the sample product.

The supply chain engine 114 as described above may be used to provide new and enjoyable foods and other products to consumers. Below are example use cases that illustrate how the supply chain engine 114 may be used to surprise and delight consumers.

In a first example, it may be derived from the purchase history that a customer has a preference for foods that are fresh, non-GMO, organic, etc. Meals may be suggested which require fresh ingredients but which also require effort to prepare. The ingredients and instructional media for such meals may be being sent to the customer and the customer's response evaluated. In addition, samples of fresh, non-GMO, organic ingredients may be sent to them with a reasonable expectation of a positive response. The information for the customer may be compiled at the individual level.

Automatically or through human expertise, it might be ascertained that a customer with a pet having these preferences might be interested in fresh dog food. Samples of fresh dog food can be sent and a response of the customer evaluated using the supply chain engine 114 as described herein. Through analytics a common thread of preferences among the preferential fabrics of customers may be identified. Consumers may be clustered based on this common thread of preferences to find other people with a similar preferential fabric who will likely respond to fresh dog food the same. Out of this cluster of people with similar preferential fabric, it could be determined that dog food with the shortest time from farm to customer opens up opportunities to contract with a manufacturer to produce a dog food that would not be possible if the normal supply chain constraints are applicable.

This same preferential fabric might lead to a very fresh multi vitamin production with natural components that might have a short shelf life that under normal supply chain constraints the product would expire before it could get to the customer. These products could be sent to the customer with a high degree of precision that they would be welcomed.

Although the examples provided herein have referenced edible ingredients such as produce and other product that have a short shelf life, the supply chain engine 114 may also be used to selected and distribute other non-edible products that may be of interest to customers. For example, the sample product could be a cooking tool. In one example, the meal profile 112d may indicate that a cluster of users prefers dishes having a descriptor of “low complexity” or “short cooking time,” or other adjective or descriptor that indicates that the users of the cluster prefer dishes with low complexity and quick preparation.

For such a cluster, a cooking tool that facilitates quick and simple preparation of meals may be selected and a response of a subset of the users of the cluster may be tested. For example, a pressure cooker may be selected as a product likely to appeal to the cluster inasmuch as it reduces cooking times and complexity.

Likewise, products may be developed based on the common thread of preferences of a cluster in order to meet unmet needs of the cluster. These products may then be tested and distributed according to the functionality of the supply chain engine 114 as described herein.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A system for supply chain management comprising:
a server system comprising one or more processors and one or more memory devices operably coupled to the one or more processors, the one or more memory devices storing executable and operational code effective to execute a supply chain engine comprising—
a customer knowledge database storing for each customer of a plurality of customers, a purchase history of items purchased by the each customer and a meal plan history of meal plans executed by the each customer;
a customer characterization module effective to identify, for each customer of the plurality of customers, a preferential fabric of the each customer, the preferential fabric including common attributes of the items of the purchase history of the each customer and ingredients of meal plans of the meal plan history of the each customer;
a clustering module effective to analyze the preferential fabrics of the plurality of customers and meal plan histories of the plurality of customers and identify a plurality of clusters of customers, each cluster being identified as group of customers from the plurality of customers that have similar preferential fabrics;
a sample module effective to (a) select, for at least one cluster of the plurality of clusters, a portion of the customers of the at least one cluster, (b) identify a sample product having similarity to the preferential fabrics of the customers of the at least one cluster meeting a threshold condition, (c) invoke shipping of a sample product to the portion of the customers of the at least one cluster, the sample product having attributes corresponding to the preferential fabrics of the customers of the at least one cluster and (d) evaluate a response of the portion of the customers of the at least one cluster to the sample product;
a meal plan module effective to select the sample product for inclusion in a sample-using meal plan scheduled on a common date for the customers of the at least one cluster of the plurality of customer if the response of the portion of the customers of the at least one cluster meets a threshold condition;
a supply chain module effective to invoke ordering and delivery of the sample product on the common date to the customers of the at least one cluster within a usable lifetime of the sample product, the sample product having a usable lifetime shorter than a time required to stock the sample product in a retail establishment for individual sale.

2. The system of claim 1, wherein the supply chain module is further effective to invoke direct shipment of the sample product and one or more other ingredients.

3. The system of claim 1, wherein the supply chain module is further effective to invoke direct shipment of the sample product and one or more other ingredients without shelving of the sample product at a retail establishment.

4. The system of claim 3, wherein the sample product is perishable and wherein the supply chain module is effective to invoke ordering and delivery within a usable lifetime of the sample product.

5. The system of claim 4, wherein the usable lifetime of the sample product is shorter than would permit shelving of the sample product at a retail establishment.

6. The system of claim 5, wherein the supply chain module is further effective to schedule shipping of the sample product for delivery within the usable lifetime of the sample product.

7. The system of claim 1, wherein the sample product is produce, the usable lifetime of the product after harvesting of the produce is less than a time required to shelve the sample product at a retail establishment.

8. The system of claim 7, wherein the supply chain module is further effective to generate an order for units of the sample product prior to a growing period of the product preceding the common date.

9. The system of claim 1, wherein the supply chain module is further effective to generate an order for units of the sample product on an order date such that the sample product can be delivered to the customers of the at least one cluster on the common date.

10. The system of claim 1, wherein the sample product is a tool to facilitate meal preparation.

11. A method for supply chain management comprising:
maintaining, by a server system, a database storing for each customer of a plurality of customers, a purchase history of items purchased by the each customer and a meal plan history of meal plans executed by the each customer;
analyzing, by the server system, the purchase histories and meal plan histories of the plurality of customers and identifying a plurality of clusters of customers having similar tastes based on similarities of the purchase histories and meal plan histories of the customers of the clusters of customers;
selecting, by the server system, for at least one cluster of the plurality of clusters, a portion of the customers of the at least one cluster;
identifying, by the server system, a sample product having sample products having similarity to the preferential fabrics of the customers of the at least one cluster meeting a threshold condition;
invoking, by the server system, shipping of a sample product to the portion of the customers of the at least one cluster
evaluating, by the server system, a response of the portion of the customers of the at least one cluster to the sample product;
selecting, by the server system, the sample product for inclusion in a sample-using meal plan scheduled on a common date for the customers of the at least one cluster of the plurality of customer in response to determining that the response of the portion of the customers of the at least one cluster meets a threshold condition;
invoking, by the server system, ordering and delivery of the sample product on the common date to the customers of the at least one cluster.

12. The method of claim 11, wherein invoking ordering and delivery of the sample product on the common date to the customers of the at least one cluster the supply chain module is further comprises invoking direct shipment of the sample product and one or more other ingredients.

13. The method of claim 11, wherein invoking ordering and delivery of the sample product on the common date to the customers of the at least one cluster the supply chain module is further comprises invoking direct shipment of the sample product and one or more other ingredients without shelving of the sample product at a retail establishment.

14. The method of claim 13, wherein invoking ordering and delivery of the sample product on the common date to the customers of the at least one cluster the supply chain module is further comprises invoking ordering and delivery within a usable lifetime of the sample product.

15. The method of claim 14, wherein the usable lifetime of the sample product is shorter than would permit shelving of the sample product at a retail establishment.

16. The method of claim 14, wherein the supply chain module is further effective to schedule shipping of the sample product for delivery within the usable lifetime of the sample product.

17. The method of claim 11, wherein the sample product is produce, the usable lifetime of the product after harvesting of the produce being less than a time required to shelve the sample product at a retail establishment.

18. The method of claim 17, wherein invoking ordering and delivery of the sample product on the common date to the customers of the at least one cluster the supply chain module further comprises generating an order for units of the sample product prior to a growing period of the product preceding the common date.

19. The method of claim 11, wherein invoking ordering and delivery of the sample product on the common date to the customers of the at least one cluster the supply chain module further comprises generating an order for units of the sample product on an order date such that the sample product can be delivered to the customers of the at least one cluster on the common date.

20. The method of claim 11, wherein the sample product is a tool to facilitate meal preparation.
